(19) United States
(12) Patent Application Publication
(10) Pub. No.: US 2011/0054942 A1
(43) Pub. Date: Mar. 3, 2011

(54) SYSTEM FOR AND METHOD OF TRANSMITTING DESCRIPTIVE PRESCRIPTION BETWEEN DOCTOR AND PATIENT

(76) Inventor: He-Doo CHUNG, Seoul (KR)

(21) Appl. No.: 12/759,490

(22) Filed: Apr. 13, 2010

(30) Foreign Application Priority Data
Aug. 26, 2009 (KR) 10-2009-79121

(51) Int. Cl. G06Q 50/00; G06Q 10/00; G06F 17/30; G06F 15/16

(52) U.S. Cl. 705/3; 707/802; 709/206; 707/E17.044

(57) ABSTRACT

A system for and a method of transmitting descriptive prescription between a doctor and a patient are disclosed. The method includes: receiving patient information on a patient, treatment information, and a list of descriptive prescription content selected by a doctor from a server access module when a request for registering a descriptive prescription is received; generating a patient account using the patient information and generating a descriptive prescription matched to the received list of descriptive prescription content to the patient account; generating access information for accessing the descriptive prescription content and a descriptive prescription viewing guide message and transmitting the same to a patient terminal; and assisting a patient computer such that the patient views the descriptive prescription by playing an unwatched descriptive prescription content registered to a personal account of the patient and storing a patient viewing record on the descriptive prescription content to a member database.

### BACKGROUND OF THE INVENTION

1. Field of the Invention

The present invention relates to a system for and a method of transmitting a descriptive prescription between a medical doctor and a patient and, more particularly, to a system for and a method for a doctor's to make a descriptive prescription by selecting medical knowledge necessary to a patient and registering the descriptive prescription at an account of the patient while the doctor treats the patient in a hospital, so that the patient, after treatment, may check and acquire the medical knowledge recommended by the doctor and therefore, the patient may easily get rid of some doubt that may occur during treatment and/or viewing the doctor's explanation/diagnosis for the patient's disease and the doctor may save time required to convey the medical knowledge to the patient.

2. Description of the Related Art

In general, there is a wide gap for medical knowledge between a doctor who provides professional medical services and a patient who receives the medical services.

In other words, an ordinary patient acquires medical information only through limited sources such as a visit to a hospital for treatment, Internet, medical books, or mass media such as newspaper, TV, and the like. Thus, a patient and/or a guardian of the patient without professional medical knowledge directly views a doctor's explanations for the patient's self or family's peculiar disease and health during treatment, or acquires medical information from bulletin boards and brochures provided in the hospital, medical books, newspapers, TV, or Internet, when the doctor's explanation is not sufficient.

However, in spite of a huge gap of medical knowledge between a patient and a doctor, even a doctor, who exactly knows a current health of the patient and what medical information the patient and/or a guardian of the patient needs, does not sufficiently explain the medical information for disease of the patient to the patient and the guardian due to time constraints, physical fatigue, and mental stress. When the patient and the guardian without professional medical knowledge do not watch sufficient explanation for a history of the disease peculiar to and current health of the patient and his/her family, the patient and the guardian must acquire the medical knowledge from another medium.

However, since such medical information is explained with terminologies and pictures which the patient and the guardian cannot easily understand due to the properties of the medical information, it is difficult for the patient and the guardian to acquire the medical information.

Recently, a great deal of medical information is disclosed on the Internet but there is no way to check whether the information is accurate. In particular, since only general information is available, without considering a patient's personal situation and health condition, the general information is also not reliable. Moreover, the middle-aged and the elderly who receive medical services more frequently than the young have difficulty using the Internet, the middle-aged and the elderly has a higher difficulty for acquiring correct medical information.

### SUMMARY OF THE INVENTION

Therefore, the present invention has been made in view of the above problems, and the present invention provides a system for and a method of transmitting descriptive prescription between a doctor and a patient by easily communicating medical information between the doctor and the patient.

In accordance with an embodiment of the present invention, there is provided a method of transmitting a descriptive prescription between a doctor and a patient, including: receiving, by a descriptive prescription management server, patient information on a patient who is currently treated, treatment information, and a list of descriptive prescription contents selected by a doctor from a server access module of an accessed doctor's office computer when a request for registering a descriptive prescription is received from the server access module of the accessed doctor's office computer; generating, by the descriptive prescription management server, a patient account using the patient information and generating a descriptive prescription matching the received list of descriptive prescription contents to the patient account; generating, by the descriptive prescription management server, access information for accessing the descriptive prescription content that is registered to the patient account and a descriptive prescription viewing guide message and transmitting the same to a corresponding patient terminal; and assisting, by the descriptive prescription management server, an patient computer such that the patient views the descriptive prescription by playing unwatched descriptive prescription content registered to a personal account of the patient and storing a patient viewing record on the descriptive prescript ion content to a member database.

In the method of transmitting descriptive prescription between a doctor and a patient according to the present invention, the difficult understandings of medical services provided by medical institutions and difficult communications between a doctor and a patient are solved so that the patient's right to know is guaranteed and quality of medical services can be improved due to easy information transmission between the doctor and the patient.

Moreover, it is possible to reduce medical malpractice disputes occurring due to an ambiguous document generated between a medical institution and a patient by obtaining an on-line agree for an operation and treatment, and to use the on-line agreement when a medical malpractice dispute occurs.

### BRIEF DESCRIPTION OF THE DRAWINGS

The objects, features and advantages of the present invention will be more apparent from the following detailed description in conjunction with the accompanying drawings, in which:

FIG. 1 is a schematic view illustrating an overall system for transmitting descriptive prescription between a doctor and a patient according to an embodiment of the present invention;

FIG. 2 is a block diagram illustrating configuration of a descriptive prescription management server employed in the system for transmitting descriptive prescription according to the embodiment of the present invention;

FIGS. 3(a), (b) and (c) are views illustrating a relationship between a program access module and a treatment program employed in the present invention;

FIGS. 4(a), (b) and (c) are flowcharts illustrating a method of transmitting descriptive prescription between a doctor and a patient according to another embodiment of the present invention;

FIG. 5 is a view illustrating an example of a screen in which descriptive prescription is registered by a computer of a doctor's office;

FIG. 6 is a view illustrating an example of a message transmitted from the descriptive prescription management server to a terminal of the patient;

FIG. 7 is a view illustrating an example of a screen for authenticating a patient;

FIG. 8 is a view illustrating an example of a screen of a patient's computer on which the descriptive prescription is displayed;

FIG. 9 is a view illustrating an example of the patient's computer; and

FIG. 10 is a view illustrating another example of the patient's computer.

### DETAILED DESCRIPTION OF EXEMPLARY EMBODIMENTS

Hereinafter, embodiments of the present invention will be described in detail with reference to the accompanying drawings.

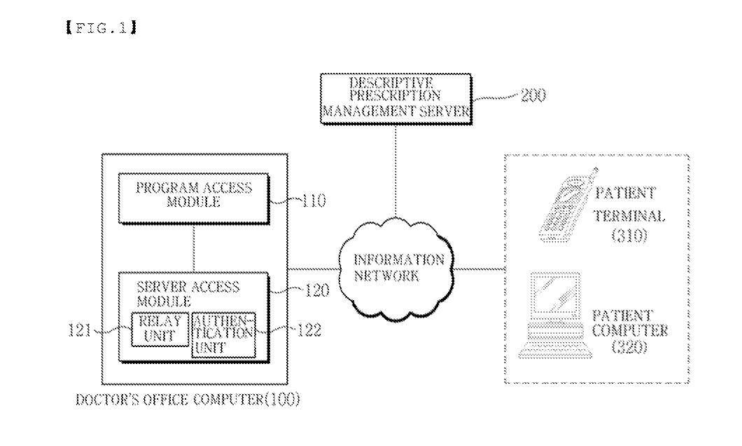

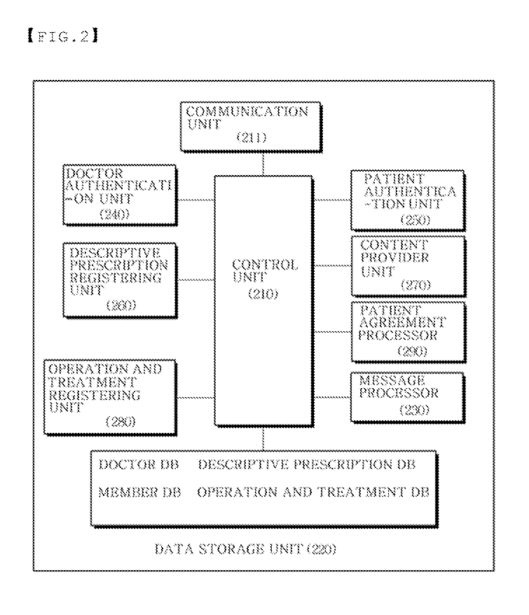

FIG. 1 is a schematic view illustrating an overall system for transmitting descriptive prescription between a doctor and a patient according to an embodiment of the present invention.

As illustrated in FIG. 1, a system for transmitting descriptive prescription between a doctor and a patient according to an embodiment of the present invention includes a doctor's office computer 100 provided in a doctor's office of a hospital, a descriptive prescription management server 200 receiving treatment information and a descriptive prescription code from the doctor's office computer 100, and a patient's terminal 310 and a patient computer 320 which are operated by a patient or the patient's guardian. The doctor's office computer 100 and the descriptive prescription management server 200 are connected to the patient's terminal 310 and the patient's computer 320 through an information communication network.

The descriptive prescription is multimedia content enabling the patient to easily understand professional and difficult medical knowledge. The descriptive prescription is managed to interlink respective content by defining additional codes for medical treatments carried out in a medical institution such as operation, treatment, examination, and the like based on disease/illness code (ICD10 code). The descriptive prescription is managed by interlinking guide information, advance warning information, and post warning information, for disease/illness and medical treatments, with the codes.

In other words, when a doctor does not explain to a patient in the doctor's office in detail in order to teach information necessary for the patient during the treatment of the patient but selects a disease code with a treatment program such as an electronic medical record (EMR), an order communication system (OCS), and an electronic medical chart which are installed in the doctor's office computer 100, the treatment program interlinks the selected disease codes with codes of operation, treatment, and examination related to the selected disease code and automatically displays a list of descriptive prescriptions related to the interlinked codes on a screen of the doctor's office computer 100 and finally the doctor selects items corresponding to the patient from the displayed list of the descriptive prescriptions.

As such, the descriptive prescription content selected by the doctor who treats the patient is transmitted to the patient so that the proper descriptive prescription content closely related to the health of the patient may be transmitted to the patient and the doctor who directly has a conversation with the patient may determine the level of medical knowledge of the patient and select the descriptive prescription content for transmission accordingly.

The doctor's office computer 100 processes the job for medical record among the treatment in the hospital/medical clinic. In the doctor's office computer 100, treatment-related programs (hereinafter, referred to as a ‘treatment program’) such as EMR, OCS, and the electronic medical chart are provided, and the doctor drives the treatment program to register and manage the treatment record of the patient based on codes.

The doctor's office computer 100 receives data from the treatment program driven in a corresponding doctor's office computer 100 through a program access module 110 installed in the doctor's office computer 100. A server access module 140 transmits the received data to the descriptive prescription management server 200.

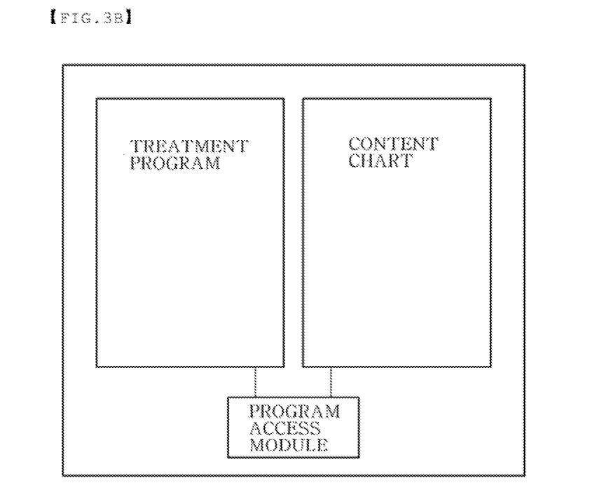

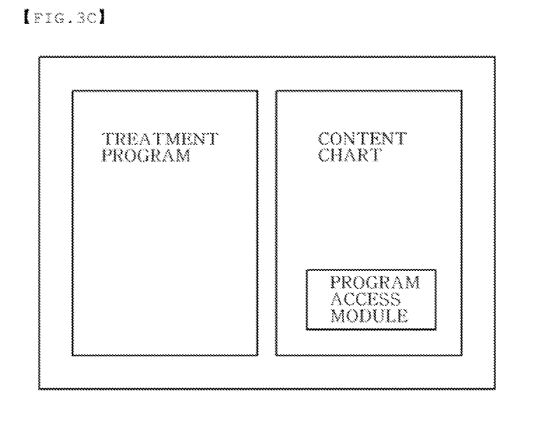

In this case, the program access module 110 of the doctor's office computer 100 may be directly synchronized with a corresponding treatment program, may be separately driven from the corresponding treatment program to receive data such that the data is relayed by the treatment program, or may be driven completely independent of the corresponding treatment program. The above-described various operations of the program access module 110 will be described with reference to FIGS. 3A to 3C, as follows.

FIGS. 3A to 3C are conceptual views illustrating a relationship between the program access module 110 and the treatment program employed in the present invention.

Basically, the program access module 110 drives a content chart interface displaying the list of the descriptive prescription content to a doctor who treats a patient to assist the doctor to select a desired list of the descriptive prescription content. Through the content chart interface, which will be described later, the doctor may check whether the patient has watched to his/her descriptive prescription and patient's viewing history of descriptive prescriptions.

The treatment programs such as EMRs, OCSs, and the electronic medical charts of respective hospitals are individually developed and customized by the respective hospitals and tinder the conditions of program developers, and therefore, a majority of the treatment programs are not standardized. Thus, the program access module 110 receiving the disease/illness codes that are input by the doctor and the codes, related to the disease/illness codes, for operation, treatment, and examination, as described above, are operated in a synchronized fashion, a relayed fashion, and an independent fashion according to situations of the hospitals and under the conditions of the system developers.

First, referring to FIG. 3A, the content chart interface in which a corresponding program access module 110 is driven is directly synchronized with the treatment program. That is, since the content chart interface in which the program access module 110 is driven serves as a service module provided by the corresponding treatment program, the program access module 110 receives the disease/illness codes that the doctor inputs through a corresponding treatment program and the codes for operation, treatment, and examination related to the disease/illness codes directly from the treatment program.

Thus, the disease/illness codes which the doctor inputs to the treatment program during treatment and the codes for operation, treatment, and examination related to the disease/illness codes are directly transmitted to the synchronized content chart interface. Then, a list of various descriptive prescription contents, which are matched to the transmitted disease/illness codes and the codes for operation, treatment, and examination related to the transmitted disease/illness codes are displayed on a corresponding content chart interface. When the doctor selects a list of descriptive prescription content suited to the patient through the content chart interface again, the selected list of the descriptive prescription content is transmitted to the program access module 110.

In this case, the program access module 110 receives patient information including a name, an identification No., a mobile phone number, and a patient code of a currently treated patient and treatment information as information on the current treatment including a hospital code, a doctor code, and curing time, from the synchronized treatment program.

Next, referring to FIG. 3B, the content chart interface in which a corresponding program access module 110 is driven is indirectly interlinked with the treatment program. The program access module 110 receives the disease/illness codes that are input by the doctor and the codes, related to the disease/illness codes, for operation, treatment, and examination from the treatment program and relays the received codes to the content chart interface, and receives the list of descriptive prescription content finally selected by the doctor through the content chart interface from the content chart interface.

Thus, the disease/illness codes that the doctor inputs to the treatment program during treatment and the codes, related to the disease/illness codes, for operation, treatment, and examination are transmitted to the content chart interface through the corresponding program access module 110. A list of various descriptive prescription content matched to the codes is displayed and the doctor selects a list of descriptive prescription content suited to the patient through the content chart interface again, so that the program access module 110 receives the selected list of descriptive prescription content.

In this case, the program access module 110 receives patient information including a name, an identification No., a mobile phone number, and a patient code of a currently treated patient and treatment information as information on current treatment including a hospital code, a doctor code, and curing time, from the corresponding treatment program.

Referring to FIG. 3C, the content chart interface in which a corresponding program access module 110 is driven is operated completely independent of the treatment program. That is, the content chart interface in which the program access module 110 is driven does not receive any codes from the corresponding treatment program. When the doctor inputs the disease/illness codes and the codes, related to the disease/illness codes, for operation, treatment, and examination, a list of descriptive prescription contents related to the codes is displayed on the content chart interface and the doctor selects a list of descriptive prescription proper to the patient through the content chart interface so that the program access module 110 receives the finally selected list of descriptive prescription content.

In this case, the program access module 110 receives patient information including a name, an identification No., a mobile phone number, and a patient code of a currently treated patient and treatment information as information on current treatment including a hospital code, a doctor code, and curing time, from the doctor.

Here, for the disease/illness codes and the codes, related to the disease/illness codes, for operation, treatment, and examination, the treatment program and the content chart interface adopt standard codes of international classification of disease (ICD).

The server access module 120 of the doctor's office computer 100 includes a relay unit 121 for transmitting the list of descriptive prescription content that is transmitted from the program access module 110 to the descriptive prescription management server 200 and for receiving data transmitted from the descriptive prescription management server 200, and an authentication unit 122 for authenticating a doctor who uses a corresponding doctor's office computer 100.

That is, the list of descriptive prescription content finally selected by the doctor through the server access module 120 is transmitted to the descriptive prescription management server 200 and the server access module 120 receives information on whether the patient has viewed his/her descriptive prescription and patient's viewing history of descriptive prescriptions from the descriptive prescription management server 200 by the doctor's request to transmit the received information to the program access module 110, so that the doctor may check and manage the record through the content chart interface. It is possible that information on whether the patient has viewed his/her descriptive prescription and patient's viewing history of descriptive prescriptions that a doctor may receive after the descriptive prescription may be checked by which the doctor checks the information after authentication on a web site managed by the descriptive prescription management server 200 not through the above-described content chart interface.

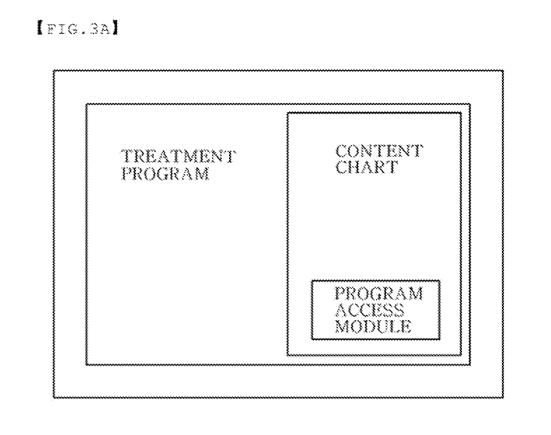

FIG. 2 shows configuration of the descriptive prescription management server 200 employed in the embodiment of the present invention. The descriptive prescription management server 200 is a descriptive prescription managing system and hereinafter will be referred to a descriptive prescription management server 200 for convenience of description.

The descriptive prescription management server 200 includes a data storage unit 220, a communication unit 211, a doctor authentication unit 240, a patient authentication unit 250, a descriptive prescription registering unit 260, a content provider unit 270, an operation/treatment registering unit 280, a patient agreement processor 290, a message processor 230, and a control unit 210 controlling the above-mentioned elements.

The communication unit 211 performs data exchange with server access modules 120 installed in the respective doctor's office computers 100 and assists a patient computer 320 to access the descriptive prescription 200 and to view a descriptive prescription assigned to the patient.

The doctor authentication unit 240 performs authentication of the authentication units 122 of the respective server access modules 120 that access the descriptive prescription management server 200 and of the authority of the doctor to authenticate the doctor. The authentication process may be carried out in various fashions such as a password input login method with the server access module 122, a certificate method using a certificate (certificate or electronic signature authentication system), and the like.

The patient authentication unit 250 performs authentication processes of respective patient computers 320 which access the descriptive prescription management server 200 for the use of the descriptive prescription content. The authentication process may be carried out in various fashions such as a password input login method with the server access module 122, a certificate method using a certificate, and the like.

When a new patient who is not a member of the descriptive prescription transmitting system is treated and a list of descriptive prescriptions and patient information are transmitted from the doctor's office computer 100, the patient authentication unit 250 provides temporary ID and password to the new patient at a first treatment to make a temporary account of the new patient such that the new patient may inquire the descriptive prescriptions within limited times. When the new patient joins, the patient authentication unit 250 may allow the new patient to inquire as to the descriptive prescriptions on the past treatment provided by other hospitals.

The descriptive prescription registering unit 260, when a list of descriptive prescriptions and patient information are transmitted from the doctor's office computer 100, registers a descriptive prescription content of a descriptive prescription database matched to the list of descriptive prescriptions selected by the doctor to a personal account of a corresponding patient.

The content provider unit 270 reads the descriptive prescription content, registered to the personal account of an patient, from the descriptive prescription database.

The content provider unit 270, because the provided descriptive prescription content is multimedia content containing moving pictures, creates information on whether the patient has viewed corresponding descriptive prescription multimedia and a viewing time and stores the information in a member database to manage the information.

The operation/treatment registering unit 280, when a list of descriptive prescriptions and patient information are transmitted from the doctor's office computer 100, reads cautions and agreement for operation and treatment from an operation and treatment database and registers the same to the personal account of the patient.

The patient agreement processor 290 provides cautions and agreements for operation and treatment that are registered to the patient from the personal account of the patient to the patient and processes whether the patient agrees.

In this case, the provision of the cautions and agreement for operation and treatment and the process of agreement by the patient are preparations for medical malpractice disputes frequently occurring between a medical institution and a patient, and may be used as definitive evidence and a legal record when the medical malpractice dispute occurs by which a doctor who prepares operation and treatment for a patient lets the patient check the cautions for operation and treatment and agree with the operation and the treatment such that information on the record of the check and agreement by the patient is managed.

The patient agreement processor 290 is configured to process whether the patient understands the cautions and agrees with the operation and treatment using a personal certificate of the patient.

When descriptive prescription content that the patient must view or the cautions and the agreement that the patient must check and agree to are selected by the doctor, the message processor 230 generates information on an access address enabling the patient to access the descriptive prescription content or the cautions and the agreement for operation and treatment and an access guide message, and transmits the access address information and the guide message to the patient terminal of the patient.

Here, the term ‘the access address information to access the descriptive prescription content or the cautions and the agreement for operation and treatment’ refers to a URL address (particularly, address of a personal account) at which the patient may check the descriptive prescription content or the cautions and the agreement for operation and treatment, or may be a URL address of a web site operated by the descriptive prescription management server 200.

The patient terminal 310 may be a mobile phone held by the patient or the patient's guardian, and the guide message may be a short message service (SMS) or a multimedia messaging service (MMS) message that may be immediately transmitted to the mobile phone.

Therefore, the patient or the patient's guardian may acquire the access address information and the access guide information through the patient terminal 310 and may check the descriptive prescription content or the cautions and the agreement for operation and treatment that are assigned to the patient or the patient guardian through the patient computer 320.

The data storage unit 220 includes a doctor database to manage personal information and authentication information of a doctor who may instruct to provide a list of descriptive prescriptions or cautions and agreement of the patient for operation and treatment through the doctor's office computer 100, a patient database to manage personal information and authentication information on the patient which is accessed by with the patient computer 320, a descriptive prescription database in which various descriptive prescriptions matched to respective disease/illness codes are managed, and an operation and treatment database in which cautions and agreement, which are matched to the codes for operation, treatment, and examination are managed.

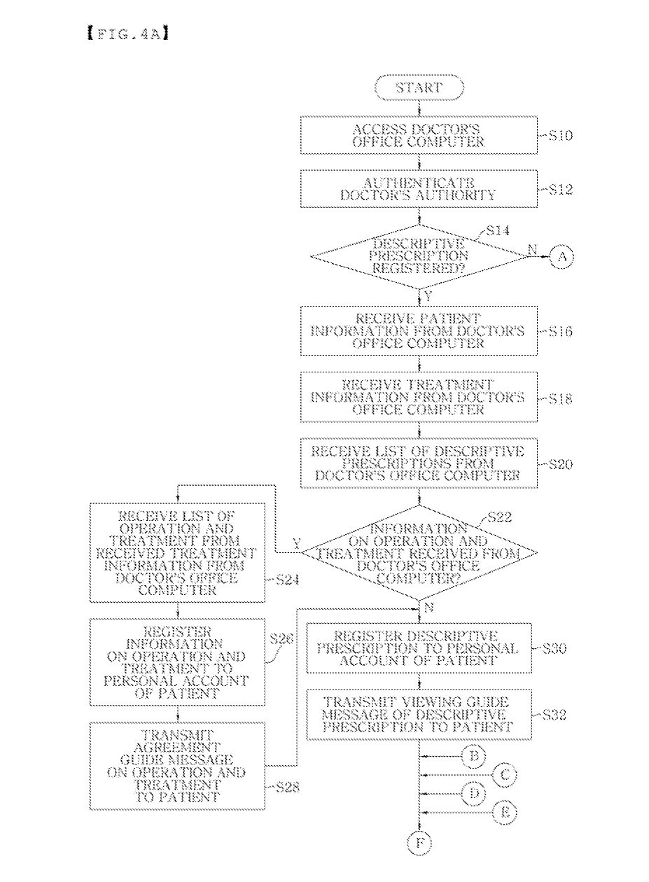

Hereinafter, a method of transmitting descriptive prescription between a doctor and a patient according to another embodiment of the present invention will be described in detail with reference to FIGS. 4(a), (b) and (c).

FIGS. 4(a), (b) and (c) are flowcharts illustrating the method of transmitting descriptive prescription between a doctor and a patient according to another embodiment of the present invention.

First, a doctor drives the treatment program, the content chart interface, and the program access module 110 in his/her doctor's office computer 100 and accesses the descriptive prescription management server 200 through the server access module 122 (S10).

In this case, the content chart interface and the program access module 110 of the doctor's office computer 100 may be directly synchronized with a corresponding treatment program, may be separately driven from the corresponding treatment program to receive data such that the data is relayed by the treatment program, or may be driven completely independent of the corresponding treatment program.

After that, the descriptive prescription management server 200 performs doctor authentication on the doctor's office computer 100 and the doctor, who launched the treatment program and the content chart interface in the doctor's office computer 100, starts to treat the patient (S12).

The descriptive prescription management server 200 determines whether data on the registration of a new descriptive prescription is transmitted from the server access module 120 of the accessed doctor's office computer 100 (S14).

As a result of the determination (S14), when the data on the registration of the new descriptive prescription is transmitted from the sever access module 120 of the accessed doctor's office computer 100, the descriptive prescription management server 200 receives patient information including a name, an identification No., a mobile phone number, and a patient code of a currently treated patient, treatment information as information on the current treatment including a hospital code, a doctor code, and treatment time, and a list of descriptive prescription content selected by the doctor through the content chart interface (S16 to S20).

The descriptive prescription management server 200 determines whether data on new operation and treatment is transmitted from the server access module 120 of the accessed doctor's office computer 100 (S22).

Unlike conventional treatment, since the transmission of the data on operation and treatment is required only when a patient has to be operated upon or treated, the descriptive prescription management server 200 extracts a personal account of a corresponding patient using the transmitted patient information and descriptive prescription content matched to the list of descriptive prescriptions selected by a doctor from the descriptive prescription database to register (S30) when the data on guide for agreement of new operation and treatment is not transmitted from the server access module 120 as a result of the determination (S22).

In this case, a temporary account of a patient who firstly receives medical services is generated using the transmitted patient information such that descriptive prescription content corresponding to the patient may be registered.

The treatment information is used as reference information for managing corresponding descriptive prescription content or for generating a viewing guide message described later.

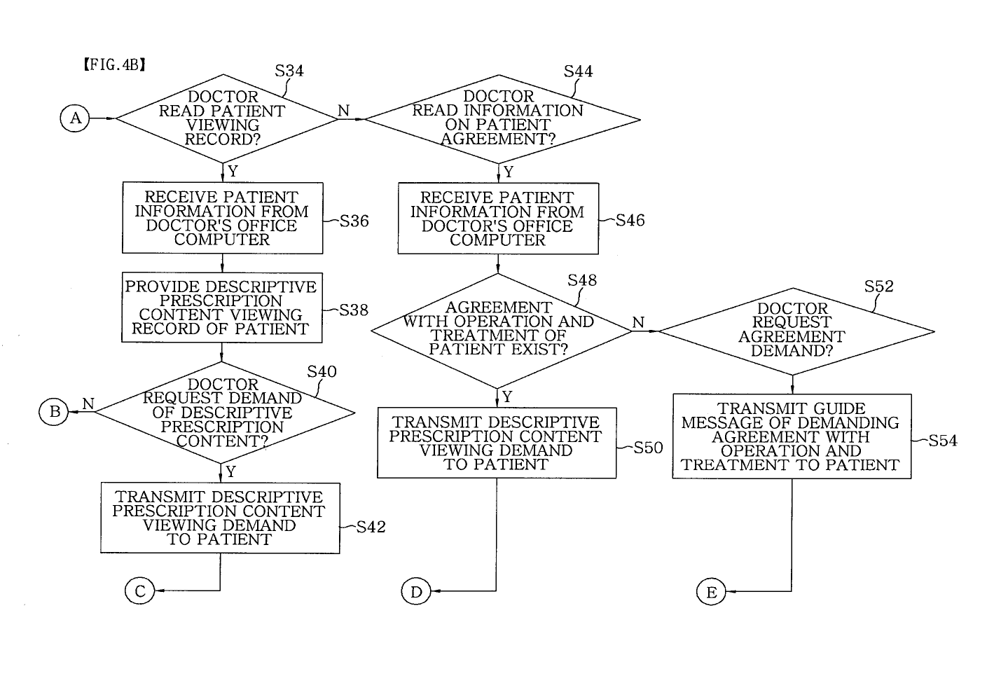

During the above process, an example of a screen in which the doctor's office computer 100 registers the descriptive prescription is shown in FIG. 5. The exemplary screen may be changed and/or modified in various forms and is only an example of the screen.

After that, the descriptive prescription management server 200 generates the access address information through which the patient may access the descriptive prescription content and the guide message for viewing the descriptive prescription in the form of an SMS or an MMS using the message processor 230 and transmits the access address and the guide message for the descriptive prescription to the patient terminal 310 (S32). As a result of the determination (S22), when the guide data for agreement of new operation and treatment is transmitted from the server access module 120 of the doctor's office computer 100, the descriptive prescription managing serve 200 receives an additional list of operations and treatments from the server access module 120 of the accessed doctor's office computer 100 (S24) and reads cautions and agreement on the operation and treatment matched to the received list of operation and treatment from the operation and treatment database to register the same to the personal account of the patient (S26).

After that, the descriptive prescription management server 200 generates the access address information through which the patient may access the cautions and the agreement on operation and treatment and the guide message in the form of an SMS or an MMS using the message processor 230 and transmits the access address and the guide message for the agreement to the patient terminal 310 (S28).

In this case, the treatment information and the patient information are used as reference information for generating the cautions and the agreement for the corresponding operation and treatment or for generating the guide message.

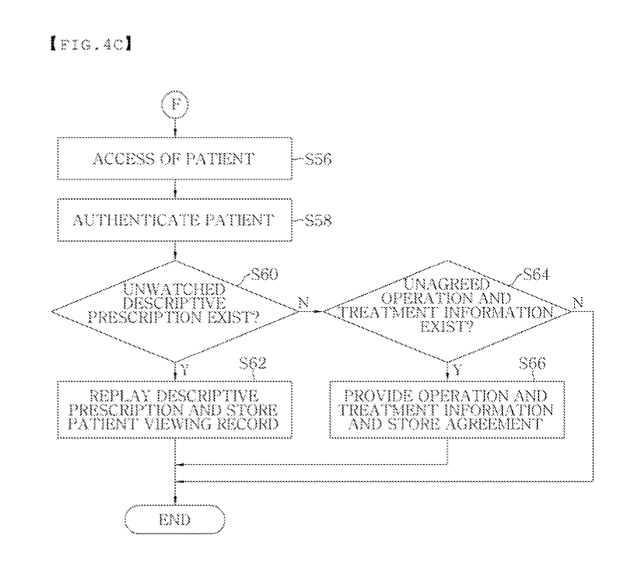

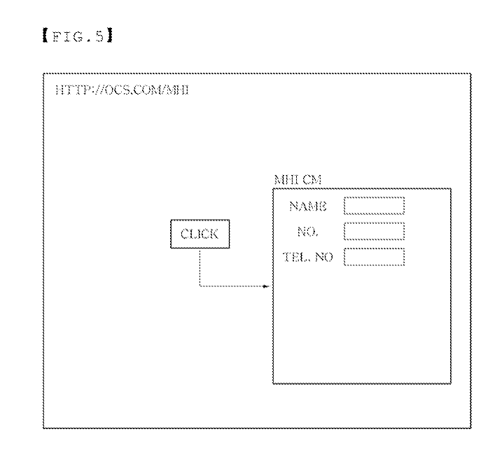

An example in which the guide message is displayed on the patient terminal 310 is shown in FIG. 6.

As illustrated in FIG. 6, the access address and the guide message for viewing the descriptive prescription are displayed on a screen of the patient terminal 310 such that the patient may check the descriptive prescription later.

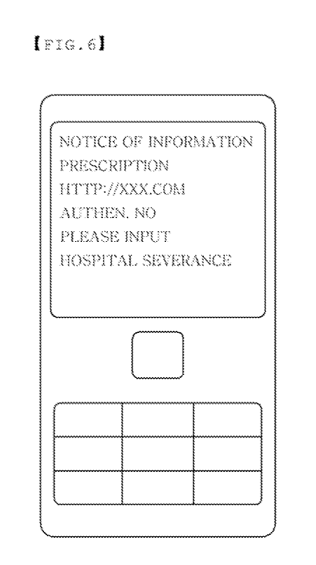

After the descriptive prescription by the doctor or the cautions and the agreement on the operation and the treatment are registered to the personal account of the patient and the guide message thereof is transmitted, the patient checks the guide message through the patient terminal 310 and inputs the address contained in the guide message to the patient computer 320 to access the descriptive prescription management server 200 (S56). The descriptive prescription management server 200 performs authentication of the patient computer 320 and the patient (S58). An example of an authentication screen is shown in FIG. 7 and the authentication screen may also be changed and modified in various forms.

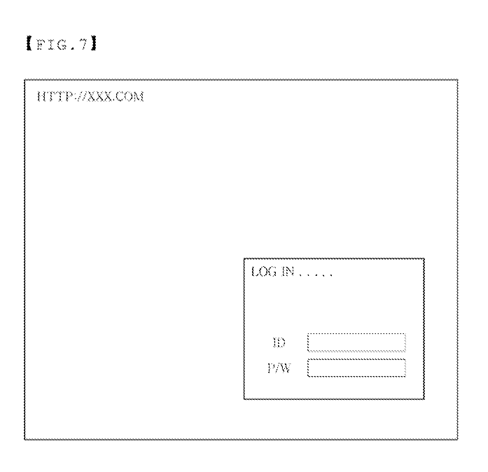

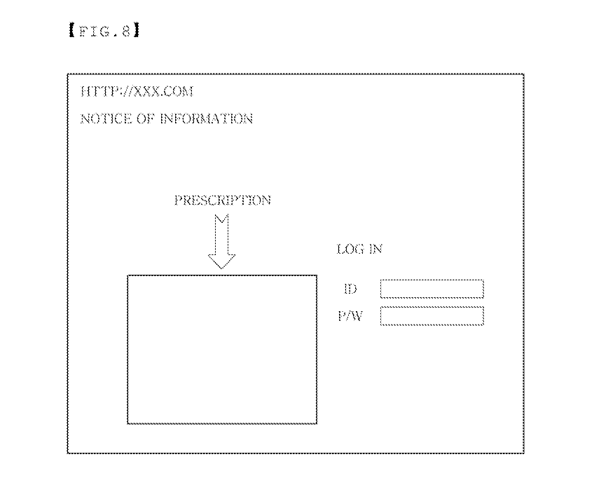

After authentication, the descriptive prescription management server 200 determines whether there is a descriptive prescription that is not watched by the patient among the descriptive prescriptions registered to the patient (S60). When there is an unwatched descriptive prescription, the descriptive prescription management server 200 assists the patient to play and watch the unwatched descriptive prescription that is registered to the patient and stores a patient viewing record including a starting time, a pausing time, a played section of the descriptive prescription content, and whether the descriptive prescription is completely watched to the member database (S62). An example of a descriptive prescription screen displayed on the patient computer 320 is shown in FIG. 8.

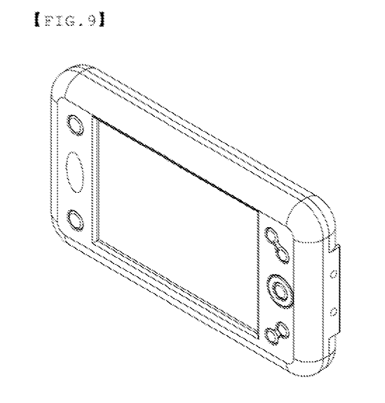

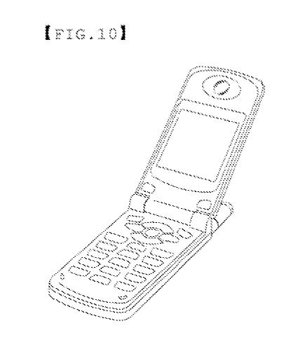

The patient computer 320 may be a simple mobile terminal as illustrated in FIG. 9, a personal digital assistant (PDA) or a mobile phone as illustrated in FIG. 10, or other terminals capable of accessing the Internet and displaying information.

The descriptive prescription management server 200 determines whether there are cautions and agreement on operation and treatment that are registered to the patient and that are not checked and agreed to (S64). When there are cautions that are not checked or an agreement that has not been agreed to, the descriptive prescription management server 200 assists the patient to check the unchecked cautions and the unagreed agreement on operation and treatment that are registered to the patient and to agree with the agreement and stores the agreement on the cautions and the agreement to which the patient agreed to the member database to manage (S66).

After registering the descriptive prescription to the personal account of the patient and transmitting the viewing guide message, the doctor may read the descriptive prescription viewing record of the patient through the doctor's office computer 100.

The descriptive prescription management server 200 determines whether a request for reading the patient viewing record on the descriptive prescription is received from the doctor's office computer 100 that accesses the descriptive prescription management server 200 and is authenticated (S34). When the request is received, the descriptive prescription management server 200 receives the patient information on the patient to be read from the doctor's office computer 100 (S36), extracts the patient viewing record including a starting time, a pausing time, a played section of the descriptive prescription content, and whether the descriptive prescription is completely watched from the member database using the patient information, and provides the extracted patient viewing record to the doctor's office computer 100 (S38).

The doctor who reads the patient viewing record may demand that the patient watch the descriptive prescription content when the patient did not view the descriptive prescription content selected by the doctor or did not view the same completely so that the doctor determines the patient may have health problems.

In other words, the descriptive prescription management server 200 determines whether a request for demanding the patient to watch the unwatched descriptive prescription content is received from the doctor's office computer 100 of the doctor who read the patient viewing record (S40). When the request for demanding the patient to watch the unwatched descriptive prescription content is received, the message processor 230 generates an access address enabling access to the unwatched descriptive prescription content and a guide message demanding that the patient view the descriptive prescription content in the form of an SMS or an MMS and the descriptive prescription managing serve 200 transmits the access address and the guide message to the patient terminal 310 (S42).

After registering the cautions for operation and treatment to the personal account of the patient and transmitting the agreement guide message as described above, the doctor may read patient agreement information on the cautions and the agreement on operation and treatment through the doctor's office computer 100.

In other words, the descriptive prescription management server 20 determines whether a request for reading the patient agreement information on the cautions and the agreement for operation and treatment is received from the accessed and authenticated doctor's office computer 100 (S44). When the request is received from the doctor, the descriptive prescription management server 200 receives the patient information from the doctor's office computer 100 (S46). When there are the cautions and the agreement checked and agreed by the patient in the member database (S48), the descriptive prescription management server 200 extracts the agreement from the member database and transmits the extracted agreement to the doctor's office computer 100 (S50).

Unlike, when there are cautions and an agreement on operation and treatment that are not yet checked and agreed to by the patient (S48), the descriptive prescription management server 200 determines whether a demand for agreement to the cautions and the agreement that are not agreed to is received from the doctor's office computer 100 (S52). When the demand is received from the doctor, the descriptive prescription management server 200 generates an access address through which the patient accesses the cautions and the agreement on operation and treatment and an agreement demanding message and transmits the access address and the agreement demanding message to the patient terminal 310 (S54).

While the invention has been shown and described with respect to the exemplary embodiments, it will be understood by those skilled in the art that the system and the method are only examples of the present invention and various changes and modifications may be made without departing from the spirit and scope of the invention as defined in the following claims.

What is claimed is:

1. A method of transmitting a descriptive prescription between a doctor and a patient, comprising:
receiving, by a descriptive prescription management server, patient information on a patient who is currently treated, treatment information on a current treatment, and a list of descriptive prescription content selected by a doctor from a server access module of an accessed doctor's office computer when a request for registering a descriptive prescription is received from the server access module of the accessed doctor's office computer;
generating, by the descriptive prescription management server, a patient account using the patient information and generating a descriptive prescription matched to the received list of descriptive prescription content to the patient account;
generating, by the descriptive prescription management server, access information for accessing the descriptive prescription content that is registered to the patient account and a descriptive prescription viewing guide message and transmitting the same to a corresponding patient terminal; and
assisting, by the descriptive prescription management server, a patient computer such that the patient views the descriptive prescription by playing unwatched descriptive prescription content registered to a personal account of the patient and storing a patient viewing record on the descriptive prescription content in a member database.

2. The method as claimed in claim 1, further comprising:
additionally receiving after the reception of the list of the descriptive prescription content, by the descriptive prescription management server, information on a list of operation and treatment of a currently treated patient from the server access module of the accessed doctor's office computer when a request for check and agreement to operation and treatment by the patient is received from the server access module of the accessed doctor's office computer;
registering, by the descriptive prescription management server, cautions and an agreement on operation and treatment that are matched to the received list of operation and treatment to the patient account;
generating, by the descriptive prescription management server, access information for accessing the cautions and the agreement to operation and treatment that are registered to the patient account and an agreement guide message and transmitting the same to the patient terminal; and
assisting, by the descriptive prescription management server, the patient computer to check and agree with the cautions and the agreement on operation and treatment that are registered to the personal account of the patient and which are not checked and agreed to and storing the agreement of the patient with the cautions and the agreement when the patient checks and agrees to the member database.

3. The method as claimed in claim 2, further comprising:
receiving after storing the agreement to the member database, by the descriptive prescription management server, the patient information to be read from the doctor's office computer when a request for reading information on the agreement of the patient with the cautions and the agreement on operation and treatment that are registered by the doctor's office computer is received from the doctor's office computer, and extracting the agreement of the patient which is checked and agreed to by the patient from the member database using the patient information to provide the same to the doctor's office computer; and
generating, by the descriptive prescription management server, access information for accessing the cautions on and the agreement to operation and treatment with which are not agreed and an agreement demanding message when an agreement demanding request for agreeing with the cautions and the agreement with which are not agreed is received from the doctor's office computer under the situation where the patient does not agree with the cautions and the agreement on operation and treatment, and transmitting the access information and the agreement demanding message to the patient terminal.

4. The method as claimed in claim 3, wherein the doctor's office computer comprises a program access module receiving data from a driven treatment program and a server access module relaying the data to the descriptive prescription management server; and
the program access module of the doctor's office computer is operated in a synchronous fashion of being synchronized directly with the treatment program, or in a relay fashion of receiving the data from the treatment program while being operated separately from the treatment program.

5. The method as claimed in claim 4, wherein, when the program access module of the doctor's office computer is synchronized, a disease code input to the treatment program by the doctor during the treat and a code, related to the disease code, on operation, treatment, and examination are directly transmitted to a synchronized chart interface, lists of descriptive prescription content that matches the disease code and the code on operation, treatment, and examination are displayed on the chart interface, the program access module receives a list of descriptive prescription content finally selected by which the doctor selects a list of descriptive prescription content again through the chart interface to transmit the received list to the server access module.

6. The method as claimed in 4, wherein, when the program access module of the doctor's office computer is operated in the synchronous fashion, the disease code input to the treatment program by the doctor during treatment and the code, related to the disease code, on operation, treatment, and examination are transmitted to the chart interface through the program access module, lists of descriptive prescription content matched to the transmitted disease code and the code related to the disease code are displayed on the chart interface, and the program access module receives again a list of descriptive prescription contents finally selected by which the doctor selects a list of descriptive prescription content again through the chart interface to transmit the received list to the server access module.

7. The method as claimed in claim 1, further comprising:
receiving, after storing a patient viewing record to the member database, by the descriptive prescription management server, the patient information to be read from the doctor's office computer when a request for reading the patient viewing record registered by the doctor's office computer is received from the doctor's office computer and extracting the patient viewing record on viewing the descriptive prescription content from the member database using the patient information; and
generating, by the descriptive prescription management server, access information for accessing an unwatched descriptive prescription content and a guide message of demanding to watch the unwatched descriptive prescription content when a request for demanding to watch the unwatched descriptive prescription content is received from the doctor's office computer, and transmitting the access information and the guide message of demanding to watch the unwatched descriptive prescription content to the patient terminal.

8. The method as claimed in claim 7, wherein the doctor's office computer comprises a program access module receiving data from a driven treatment program and a server access module relaying the data to the descriptive prescription management server; and
the program access module of the doctor's office computer is operated in a synchronous fashion of being synchronized directly with the treatment program, or in a relay fashion of receiving the data from the treatment program while being operated separately from the treatment program.

9. The method as claimed in claim 1, wherein the doctor's office computer comprises a program access module receiving data from a driven treatment program and a server access module relaying the data to the descriptive prescription management server; and
the program access module of the doctor's office computer is operated in a synchronous fashion of being synchronized directly with the treatment program, or in a relay fashion of receiving the data from the treatment program while being operated separately from the treatment program.

10. The method as claimed in claim 2, wherein the doctor's office computer comprises a program access module receiving data from a driven treatment program and a server access module relaying the data to the descriptive prescription management server; and
the program access module of the doctor's office computer is operated in a synchronous fashion of being synchronized directly with the treatment program, or in a relay fashion of receiving the data from the treatment program while being operated separately from the treatment program.

11. The method as claimed in claim 9, wherein, when the program access module of the doctor's office computer is synchronized, a disease code input to the treatment program by the doctor during treatment and a code, related to the disease code, on operation, treatment, and examination are directly transmitted to a synchronized chart interface, lists of descriptive prescription content that are matched to the disease code and the code on operation, treatment, and examination are displayed on the chart interface, the program access module receives a list of descriptive prescription content finally selected by which the doctor selects a list of descriptive prescription content again through the chart interface to transmit the received list to the server access module.

12. The method as claimed in claim 9, wherein, when the program access module of the doctor's office computer is operated in the synchronous fashion, the disease code input to the treatment program by the doctor during treatment and the code, related to the disease code, on operation, treatment, and examination are transmitted to the chart interface through the program access module, lists of descriptive prescription content matched to the transmitted disease code and the code related to the disease code are displayed on the chart interface, and the program access module re-receives a list of descriptive prescription content finally selected by which the doctor selects a list of descriptive prescription content again through the chart interface to transmit the received list to the server access module.

13. A system for communicating with at least one doctor's office computer and transmitting a descriptive prescription between a doctor and a patient, the system comprising:
a data storage unit including:
a doctor database to manage personal information and authentication information on a doctor who instructs provision of a list of descriptive prescriptions, cautions on and an agreement with operation and treatment to a patient through the doctor's office computer;
a patient database to manage personal information and authentication information on a patient that is accessed by a patient computer;
a descriptive prescription database to manage various descriptive prescription content matched to respective disease codes; and
an operation and treatment database to manage caution information and an agreement that are matched to the code on operation, treatment, and examination;
a communication unit performing data exchange with the doctor's office computer and assisting an individual patient computer to access and watch descriptive prescription content assigned to the patient computer through an information network;
a doctor authentication unit performing authentication of the doctor by performing an authentication process of the doctor in association with the doctor's office computer;
a patient authentication unit performing an authentication process on respective patient computers that access the descriptive prescription content;
a descriptive prescription registering unit registering the descriptive prescription content of the descriptive prescription database that is matched to a list of descriptive prescription contents selected by the doctor to the personal account of the patient when the list of descriptive prescription content and the patient information are transmitted from the doctor's office computer for treatment of the patient;
a content provider unit reading the descriptive prescription content registered from the personal account of a patient to a corresponding patient from the descriptive prescription database and providing the read descriptive prescription content;
an operation and treatment registering unit reading cautions on and an agreement with a corresponding operation and treatment from the operation and treatment database and registering the read cautions and the agreement to the personal account of the corresponding patient when the list of operation and treatment and the patient information are transmitted from the doctor's office computer during treatment of the patient;
a patient agreement processor providing the cautions on and the agreement with operation and treatment that are registered from the personal account of the patient to the patient and processing whether the corresponding patient agrees with the operation and the cautions; and
a message processor generating an access address for accessing the descriptive prescription content and the cautions on and the agreement with operation and treatment and an access guide message when the descriptive prescription content that the patient has to watch and the cautions on and the agreement with operation and treatment with which the patient has to check and agree are determined by the doctor's office computer, and transmitting the address information and the guide message to the patient terminal of the corresponding patient.

14. The system as claimed in claim 13, wherein the content provider unit generates information on whether the patient views the provided descriptive prescription content and information on which the patient views the provided descriptive prescription content and transmits the same to a member database of the corresponding patient.
